(19) United States
(12) Patent Application Publication
(10) Pub. No.: US 2017/0075598 A1
(43) Pub. Date: Mar. 16, 2017

(54) IN-MEMORY STORAGE FOR REAL-TIME OR BULK DATA ACCESS

(71) Applicant: International Business Machines Corporation, Armonk, NY (US)

(72) Inventors: Anthony T. Sofia, Highland, NY (US); Elpida Tzortzatos, Lagrangeville, NY (US)

(21) Appl. No.: 14/852,754

(22) Filed: Sep. 14, 2015

(51) Int. Cl. G06F 3/06

(52) U.S. Cl. CPC G06F 3/0619; G06F 3/0688; G06F 3/0656; G06F 3/065

(57) ABSTRACT

A system that collects statistics and auditing information may receive a first request from an analytics application to access a first set of data. An application program interface (API) of the system may access the first set of data within an in-memory buffer of the system. The first set of data may be retained within the in-memory buffer as defined by a policy. The policy may include retaining the first set of data within the in-memory buffer even after the first set of data is written to non-volatile storage.

### BACKGROUND

This disclosure relates generally to a system that collects statistics and auditing information, and more specifically, to in-memory storage and access of real-time and/or bulk data in such systems.

System Management Facilities (SMF) is a component of an operating system (e.g., IBM z systems™ platform operating system) that collects statistics and auditing information of activities associated with user installations and writes out corresponding records to a file (e.g., data set) or log stream. For example, a user may desire to determine a quantity of password violations and denied access attempts to audit security and consequently generate an access request for an associated report by requesting Resource Access Control Facility (RACF) type 80 records, which gives the desired information. A record is a specific auditing or statistical unit of information. There are numerous record types associated with various types of information that are available to users. For example, a user may request record type 118, which provides access to statistics about Telnet and File Transfer Protocol (FTP) servers, a quantity and type of Application Program Interface (API) calls, and a quantity and type of Telnet and FTP client calls.

Other examples of the types of information contained in various records include accounting information (e.g., CPU time, storage usage, device usage, etc.), system information (e.g., wait time and I/O configuration), and volume information (e.g., space available on direct access volumes and error statistics for tape volumes), etc. By generating analyses based on the statistics contained in records, installation managers or system programmers can use the SMF-collected information in various manners. For example, users may utilize accounting information to measure system performance.

### SUMMARY

One or more embodiments are directed to a computer-implemented method, a system, and a computer program product. A system that collects statistics and auditing information may receive a first request from an analytics application to access a first set of data. An application program interface (API) of the system may access the first set of data within an in-memory buffer of the system. The first set of data may be retained within the in-memory buffer as defined by a policy. The policy may include retaining the first set of data within the in-memory buffer even after the first set of data is written to non-volatile storage.

### BRIEF DESCRIPTION OF THE DRAWINGS

FIG. 1 is a block diagram of a typical SMF system.

FIG. 2 is a block diagram of a computing device that includes a memory storage and consumption system, according to embodiments.

FIG. 3 is a block diagram of the memory storage and consumption system of FIG. 2, the system providing in-memory storage and access of real-time and/or bulk data, according to embodiments.

FIG. 4 is a flow diagram of an example process for copying and accessing data from a buffer pool according to a policy in a system that collects statistics and auditing information, consistent with embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate generally to in-memory storage and access of real-time and/or bulk data in systems that collect statistics and provide auditing information. While the present disclosure is not necessarily limited to such application, various aspects of the disclosure may be appreciated through a discussion of various examples using this context.

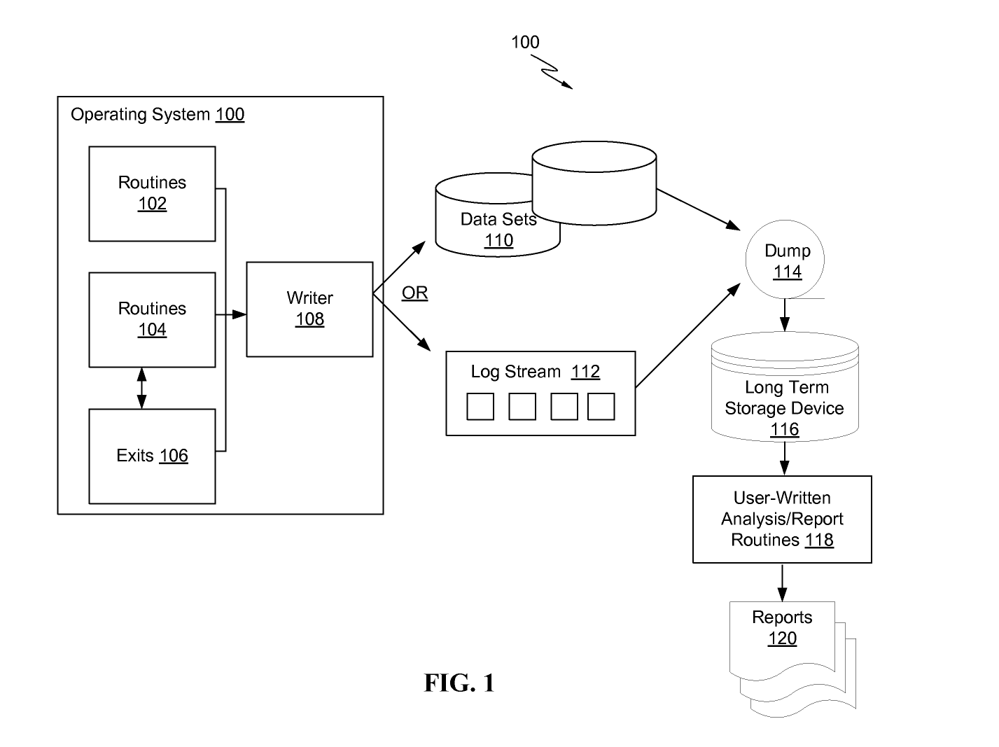

In order to access data, analytics applications that utilize systems that collect statistics and provide auditing information (e.g., SMF systems, Linux system logs, application logs, etc.) may have to wait to access the data until the data has been written to a storage device (i.e., non-volatile storage, persistent storage, etc.) such as a disk, which can be very costly in terms of disk input/output (I/O) to retrieve the data. For example, FIG. 1 is a block diagram of a typical SMF system 100. The SMF system 100 includes an operating system 100, which includes routines 102, routines 104, exits 106, and a writer 108. The SMF system further includes data sets 110, a log stream 112, a dump 114, a long-term storage device 116, user-written analysis/report routines 118, and the reports 120.

FIG. 1 represents the flow of data as it is received, written to a storage device, and accessed by an analytics application. The routines 102 collect and format data into records to be passed on to the writer 108. A routine (or sub routine) is a function or procedure, invoked by a particular application or system component that performs a particular task. The routines 102 may be system-defined routines. Examples of the routines 102 include: I/O support routines, Virtual Storage Access Method (VSAM) routines, Job Entry Subsystem (JES) routines, etc.

Some of the routines of the SMF system 100, such as routines 104 interface with exits 106 to pass control to the exits 106 at several points during a job and processing. Exits 106 monitor a job or a job step at various points during a job cycle. Exits 106 may receive control when specific events occur, such as when a data set (e.g., data set 110) exceeds the output limit or at designated points during job processing. User-written routines linked to exits may perform functions such as: cancel jobs, write user-defined records to the SMF data set (e.g., data sets 110), or enforce standards (e.g., user identification, resource allocation, and maximum execution time).

The writer 108 receives the records from the routines 102, the routines 104, and the exits 106 using macros. The writer 108 may then copy the records to buffers in order to write the records to either the data sets 110 (e.g., files) or the log stream 112 (but not both). As soon as data is transferred to the data sets 110 or log stream 112, the data may then be discarded from the buffers so that it can be re-used to keep the total memory usage as low as possible. A log stream 112 is a sequence of data blocks, with each log stream identified by its own log stream identifier—the log stream name (LSN). When records are written to the data sets 110, the data sets 110 are filled one at a time. While SMF can write records on one data set, the other data sets that are filled can be dumped (e.g., cleared, such as in dump 114). If the writer 108 writes records to the log stream 112, users may define thresholds for how much data is held before offload (e.g., dump 114).

The SMF system 100 dumps 114 programs copy data from either the data sets 110 or log streams 112 to a long-term storage device 116 (e.g., tape, disk, direct access data sets) for permanent storage (e.g., non-volatile or persistent storage). At this point, an analysis/report routine 116 (e.g., an analytics application) may read the records from the storage device 116. During the read operation, the analysis/report routine 118 may list the dumped data, use a sort/merge program to order the SMF-recorded information, and investigate or analyze a particular data item (e.g., job CPU). The analysis/report routine 118 may then format and print the statistics and/or results of the routines contained in one or more reports 120.

As discussed above, the analytics applications (e.g., the analysis/report routines 118) may not be able to have access to the data until it is written to a permanent storage device. Further data within buffers may quickly be disposed. Accordingly, needing real-time data by an analytics application may be unachievable. Further, it is expensive both in terms of time and resources to wait until data is written to a storage device to access data. Real-time analytics is the use (or capacity to use) data and resources when they are needed (e.g., data used within 1 minute of being entered into a system). With the recent development of large memory storage capacities in systems that collect statistics and auditing information for analytics applications, real-time data access is feasible. Accordingly, embodiments of the present disclosure are directed to accessing, by system that collects statistics and audition information, real-time data (or bulk data) within an in-memory buffer of the system, and retaining the real-time data within the buffer as defined by a policy.

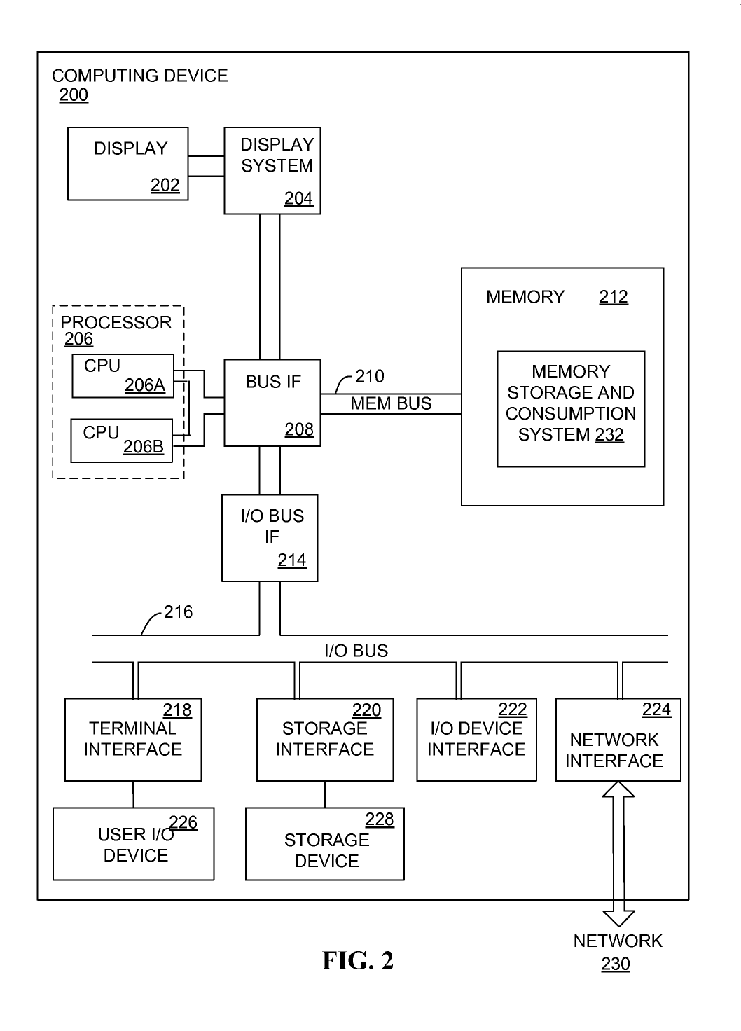

FIG. 2 is a block diagram of a computing device 200 that includes a memory storage and consumption system, according to embodiments. The components of the computing device 200 can include one or more processors 206, a memory 212, a terminal interface 218, a storage interface 220, an Input/Output (“I/O”) device interface 222, and a network interface 224, all of which are communicatively coupled, directly or indirectly, for inter-component communication via a memory bus 210, an I/O bus 216, bus interface unit (“IF”) 208, and an I/O bus interface unit 214.

The computing device 200 may include one or more general-purpose programmable central processing units (CPUs) 206A and 206B, herein generically referred to as the processor 206. In an embodiment, the computing device 200 may contain multiple processors; however, in another embodiment, the computing device 200 may alternatively be a single CPU device. Each processor 206 executes instructions stored in the memory 212.

The computing device 200 may include a bus interface unit 208 to handle communications among the processor 206, the memory 212, the display system 204, and the I/O bus interface unit 214. The I/O bus interface unit 214 may be coupled with the I/O bus 216 for transferring data to and from the various I/O units. The I/O bus interface unit 214 may communicate with multiple I/O interface units 218, 220, 222, and 224, which are also known as I/O processors (IOPs) or I/O adapters (IOAs), through the I/O bus 216. The display system 204 may include a display controller, a display memory, or both. The display controller may provide video, audio, or both types of data to a display device 202. The display memory may be a dedicated memory for buffering video data. The display system 204 may be coupled with a display device 202, such as a standalone display screen, computer monitor, television, a tablet or handheld device display, or another other displayable device. In an embodiment, the display device 202 may include one or more speakers for rendering audio. Alternatively, one or more speakers for rendering audio may be coupled with an I/O interface unit. In alternate embodiments, one or more functions provided by the display system 204 may be on board an integrated circuit that also includes the processor 206. In addition, one or more of the functions provided by the bus interface unit 208 may be on board an integrated circuit that also includes the processor 206.

The I/O interface units support communication with a variety of storage and I/O devices. For example, the terminal interface unit 218 supports the attachment of one or more user I/O devices, which may include user output devices (such as a video display devices, speaker, and/or television set) and user input devices (such as a keyboard, mouse, keypad, touchpad, trackball, buttons, light pen, or other pointing devices). A user may manipulate the user input devices using a user interface, in order to provide input data and commands to the user I/O device 226 and the computing device 200, may receive output data via the user output devices. For example, a user interface may be presented via the user I/O device 226, such as displayed on a display device, played via a speaker, or printed via a printer.

The storage interface 220 supports the attachment of one or more disk drives or direct access storage devices 228 (which are typically rotating magnetic disk drive storage devices, although they could alternatively be other storage devices, including arrays of disk drives configured to appear as a single large storage device to a host computer, or solid-state drives, such as a flash memory). In another embodiment, the storage device 228 may be implemented via any type of secondary storage device. The contents of the memory 212, or any portion thereof, may be stored to and retrieved from the storage device 228 as needed. The I/O device interface 222 provides an interface to any of various other I/O devices or devices of other types, such as printers or fax machines. The network interface 224 provides one or more communication paths from the computing device 200 to other digital devices and computer systems.

Although the computing device 200 shown in FIG. 2 illustrates a particular bus structure providing a direct communication path among the processors 206, the memory 212, the bus interface 208, the display system 204, and the I/O bus interface unit 214, in alternative embodiments the computing device 200 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 214 and the I/O bus 208 are shown as single respective units, the computing device 200, may include multiple I/O bus interface units 214 and/or multiple I/O buses 216. While multiple I/O interface units are shown, which separate the I/O bus 216 from various communication paths running to the various I/O devices, in other embodiments, some or all of the I/O devices are connected directly to one or more system I/O buses.

In various embodiments, the computing device 200 is a multi-user mainframe computer system, a single-user system, or a server computer or similar device that has little or no direct user interface, but receives requests from other computer systems (clients). In other embodiments, the computing device 200 may be implemented as a desktop computer, portable computer, laptop or notebook computer, tablet computer, pocket computer, telephone, smart phone, or any other suitable type of electronic device.

In an embodiment, the memory 212 may include a random-access semiconductor memory, storage device, or storage medium (either volatile or non-volatile) for storing or encoding data and programs. For example, the memory 212 may store the memory storage and consumption system 232, which is described in more detail below. In another embodiment, the memory 212 represents the entire virtual memory of the computing device 200, and may also include the virtual memory of other computer systems coupled to the computing device 200 or connected via a network 230. The memory 212 may be a single monolithic entity, but in other embodiments the memory 212 may include a hierarchy of caches and other memory devices. For example, memory may exist in multiple levels of caches, and these caches may be further divided by function, so that one cache holds instructions while another holds non-instruction data, which is used by the processor. Memory 212 may be further distributed and associated with different CPUs or sets of CPUs, as is known in any various so-called non-uniform memory access (NUMA) computer architectures.

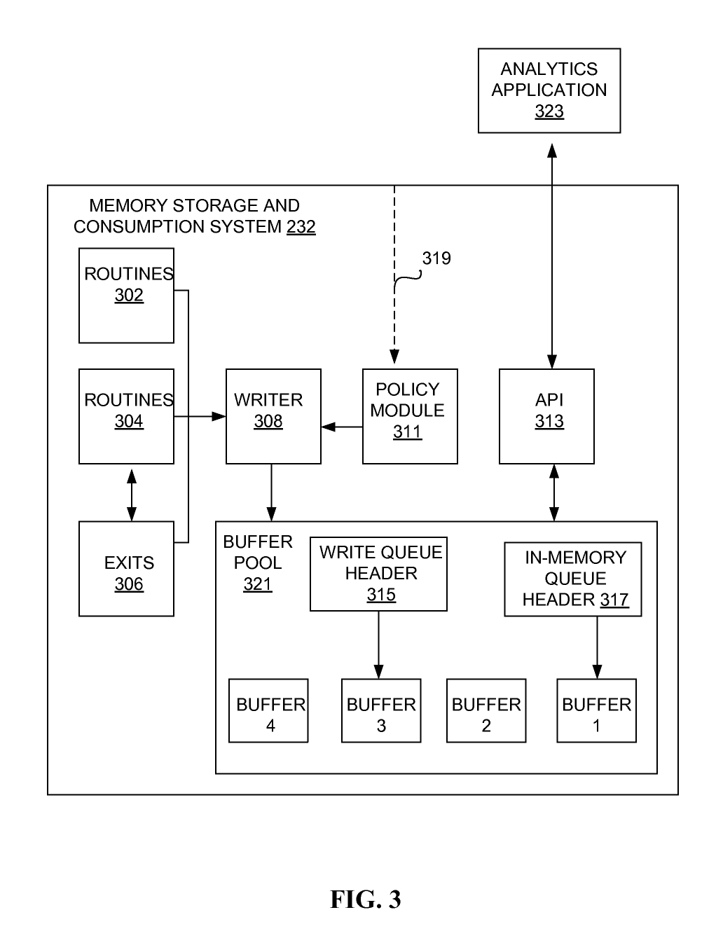

The memory 212 may store all or a portion of the components and data shown in FIG. 3. These programs and data structures are illustrated in FIG. 3 as being included within the memory 212 in the computing device 200; however, in other embodiments, some or all of them may be on different computer systems and may be accessed remotely, e.g., via a network 230. The computing device 200 may use virtual addressing mechanisms that allow the programs of the computing device 200 to behave as if they only have access to a large, single storage entity instead of access to multiple, smaller storage entities. Thus, while the components and data shown in FIG. 3 are illustrated as being included within the memory 212, these components and data are not necessarily all completely contained in the same location at the same time. Although the components and data shown in FIG. 2 are illustrated as being separate entities, in other embodiments some of them, portions of some of them, or all of them may be packaged together.

In an embodiment, the components and data shown in FIG. 3 may include instructions or statements that execute on the processor 206 or instructions or statements that are interpreted by instructions or statements that execute the processor 206 to carry out the functions as further described below. In another embodiment, the components shown in FIG. 3 may be implemented in hardware via semiconductor devices, chips, logical gates, circuits, circuit cards, and/or other physical hardware devices in lieu of, or in addition to, a processor-based system. In an embodiment, the components shown in FIG. 3 may include data in addition to instructions or statements.

FIG. 2 is intended to depict representative components of the computing device 200. Individual components, however, may have greater complexity than represented in FIG. 2. In FIG. 2, components other than or in addition to those shown may be present, and the number, type, and configuration of such components may vary. Several particular examples of additional complexity or additional variations are disclosed herein; these are by way of example only and are not necessarily the only such variations. The various program components illustrated in FIG. 2 may be implemented, in various embodiments, in a number of different ways, including using various computer applications, routines, components, programs, objects, modules, data structures etc., which may be referred to herein as “software,” “computer programs,” or simply “programs.”

FIG. 3 is a block diagram depicting the memory storage and consumption system 232 of FIG. 2, the system providing in-memory storage and access of real-time and/or bulk data, according to embodiments. The In-memory storage and consumption system 232 includes routines 302, routines 304, exits 306, a writer 308, a policy module 311 that may be implemented by a user request 319, an API (Application Program Interface) 313, a buffer pool 321 that includes a write queue header 315, and in-memory queue header 317, and four buffers (buffers 1-4). In other embodiments, there are more or less buffers as illustrated in FIG. 3 (i.e., 1−N buffers). The analytics application 323 communicates with the memory storage and consumption system 232 to request particular data records. In some embodiments, the analytics application 323 includes its own analyzing and processing capabilities, and may not have direct access to any data (e.g., to the buffer pool 321), but rather interfaces with the API 313 for data.

The routines 302 collect and format data into records to be passed on to the writer 308. The routines 302 may be system-defined routines. Some of the routines of the In-memory storage and consumption system 232, such as routines 304 may interface with exits 306 to pass control to the exits 306 at several points during a job and processing. Exits 306 monitor a job or a job step at various points during a job cycle. Exits 306 may receive control when specific events occur, such as when a data set exceeds the output limit or at designated points during job processing. User-written routines linked to exits 306 may perform functions such as: cancel jobs, write user-defined records to the data set, or enforce standards (e.g., user identification, resource allocation, and maximum execution time).

The writer 308 receives the records from the routines 302, the routines 304, and the exits 306 using macros. The writer 308 may then copy the records to the buffers (e.g., buffer 1, 2, 3, and 4) based on the policies identified by the policy module 311. In some embodiments, the writer 308 only writes or copies the records to buffers (e.g., buffers 1, 2, 3 and/or 4) in a memory storage and consumption system that does not include a storage device (which may be useful for real-time data access). In other embodiments, the writer 308 writes the records to storage devices (e.g., long-term storage device 116 of FIG. 1) in addition to writing the records to buffers, as described in more detail below.

The policy module 311 identifies (and in some embodiments determines) the policies and rules associated with data record writing and overwriting to the buffers. In some embodiments, the data records are retained in the buffers even after the data records are written to a storage device for continuous real-time data access and/or bulk retrieval of data, as described in more detail below. Accordingly, because data records may be written and stored indefinitely to the buffers, the policy module 311 may define how long the data records are to be stored in the buffers as well as the method of storing buffers for memory conservation purposes. Hence, the policy module 311 can provide benefits related to managing data in the buffers. For example, if an application needs 1 GB of buffer space to be used for in-memory data cache, a policy may specify overwriting the oldest-in-time data in particular buffer(s) with the new requested data (e.g., utilizing a wrap-around buffer). Additionally, the policy may specify that the oldest buffer cannot be overwritten until the associated data has been read. Accordingly, the memory storage and consumption system 232 may have to stop accepting new data temporarily until the oldest data has been read at least once. Any policy may be utilized for the memory storage and consumption system 232. In some embodiments, the policy module 311 (or associated computing device) determines the policy or rules to be utilized. In other embodiments, an application or installation defines the policies, as indicated by the request 319.

The buffer pool 321 may include any quantity of suitable buffers depending on the policies and/or the quantity of storage space available in the memory storage and consumption system 232. As illustrated in the example shown in FIG. 3, there are 4 buffers (buffers 1, 2, 3, and 4), a write queue header 315 and an in-memory queue header 317. Buffer 1 represents a storage space for the data that has been stored the longest quantity of time (i.e., the oldest data). The in-memory queue header 317 provides reference (e.g., for the API 313) to the oldest data (e.g., records) available (e.g., data within buffer 1), according to the policy module 311 to provide bulk access to data, as described in more detail below. In some embodiments, the write queue header 315 provides reference (e.g., for the API 313) to the buffer of data that was most recently written to (e.g., buffer 3) after a particular request for data (i.e., the newest data). In some embodiments, the write queue header 315 provides reference to the buffer of data that will be written to next. In some embodiments, the write queue header 315 provides reference to the buffer of data records that needs to be processed and written to a storage device (e.g., storage device 116 of FIG. 1). Accordingly, using the illustration of FIG. 3, after the data records within buffer 3 are written to a storage device, the write queue header 315 moves to buffer 4. As described in more detail below, the write queue header 315 may be utilized to access real-time data from the buffers. In some embodiments, various other headers other than the write queue header 315 and the in-memory queue header 317 may be utilized. For example, if a user wanted to request bulk data that was not necessarily the oldest data (corresponding to in-memory queue header 317) or the most recent data (corresponding to write queue header 315), such as a particular set of data within a time-stamped interval, then such other headers may be utilized to provide reference to those sets of data. The term “set of” as disclosed herein may mean “one or more of”.

According to embodiments, the types of data records that are stored in the buffers may be any suitable type such as a single type, multiple type, or include subtype characteristics. For example, the memory storage and consumption system 232 may be a SMF system, and may accordingly store each of the 255 potential types of records used in conventional SMF systems (e.g., record type 0—IPL, record type 2—Dump Header, record type 3—Dump Trailer, etc.).

In various embodiments the API 313 is an application program interface that provides bulk and/or real-time access to particular data records, depending on what an installation or analytics application 323 needs. An API as disclosed herein may mean a set of routines, code, protocols and/or tools that allows two or more software applications (that are not part of the same application) to communicate with each other. In an example illustration, the analytics application 323 is a real-time analytics application and therefore needs real time data (e.g., to perform its own analysis of data). For example, the analytics application 323 may desire to utilize dynamic accounting information found in the buffer pool 321 in order to measure dynamic system performance. The analytics application 323 may accordingly make adjustments with respect to any dynamic performance spikes (e.g., based on the real-time data received from the buffer pool 321) above or below a threshold. In these embodiments, the analytics application 323 may query the API 313 directly when executing in the same computing device (e.g., computing device 200 of FIG. 2) or via a network environment (e.g., utilizing the network 230 and the network interface 224 of FIG. 2). The analytics application 323 may be requesting particular real-time data in order to do real-time analyses. The API 313 may receive the request from the analytics application 323 and locate the requested data via the write queue header 315 to locate the data within buffer 3. After the data is located in buffer 3, the API 313 transmits the data to the analytics application 323. Real-time data may be transmitted back to the analytics application 323 utilizing various call mechanisms at various periods of time. For example, the analytics application 323 may poll the memory storage and consumption system 232 every 1 second such that the API 313 provides the analytics application 323 with data every second (or shortly after 1 second) or the application can request that the API 313 blocks execution until new data is available. This may be in contrast to applications today that may only be able to retrieve data at an hourly or half-hourly basis (e.g., batch mode) after the data has been written to a storage device (e.g., the long-term storage device 116 of FIG. 1).

In some embodiments, the API 313 includes synchronizing capabilities, which allows the analytics application 323 to catch up to real-time. For example, at a first time, the analytics application 323 may issue a first request and access real-time data but then break from the access (e.g., stop polling for particular data records for 10 minutes). In response to the break, the API 313 may stop accessing the data. The API 313 may, at a second time receive a request from the analytics application 323 to resume real-time data access at a point corresponding with the stopping. The API 313 may accordingly synchronize the analytics application 323 with the real-time data by keeping the last record returned before the break and providing the next record available after the break and continue providing additional records until there is no more data. This may be useful, for example, if the analytics application 323 was unexpectedly consuming data at a slower than anticipated pace. In such an example, the analytics application 323 may miss data and the associated users may desire break and re-sync to the newest data at a later time.

In some embodiments, the API 313 includes subscription capabilities. Subscription capabilities allow the API 313 to provide access to a specific record type that is stored to the buffer pool 321 as opposed to all of the record types that are in the buffer pool 321. For example, the analytics application 323 may only request record type 89 (usage data) in a SMF system for use in real-time analysis and the API 313 may only return data as a part of record type 89.

In some embodiments, the API 313 includes “bulk” data gathering capabilities for particular requests of the analytics application 323. The term “bulk,” as disclosed herein may mean data chunking, blocking, or any other method where an application requests two or more units of data for a single request. In an example illustration, on a second day, the analytics application 323 may issue a request to provide (e.g., chunk) all of the data gathered starting on a first day (that is prior to the second day) and ending on a current time of the second day to the analytics application 323. In these embodiments, the analytics application 323 may catch up to the real-time data analysis by gathering data for the days (or other units of time, e.g., hours, etc.) that the analytics application 323 did not gather the data. The analytics application 323 may accordingly query the API 313 for the first day's data and the API 313 may also utilize the in-memory queue header 317 to locate all of the data stored to buffer 1 corresponding to the latest data stored on the second day.

In some embodiments, the bulk access of the data may be based on a time range, as described above. For example, each data record that is stored to the buffer pool 321 may include a time stamp that specifies the time that the data was stored to the buffer pool 321. Accordingly, the analytics application 323 may include in its query a time range of data it wants (e.g., 10 a.m. to 3 p.m.) such that all of the data records that were written to the buffer pool 321 within the time range will be returned to the analytics application 323 via the API 313. In other embodiments, a query service that is associated with a separate server computing device may determine the time stamps of all of the data written to the buffer pool 321 and the current time range of data available in the buffer pool 321 for a specific record type.

In some embodiments, the bulk access to the data is based on a record type. For example, in an SMF system, the analytics application 323 may only request record type 7 (data lost) for the first day.

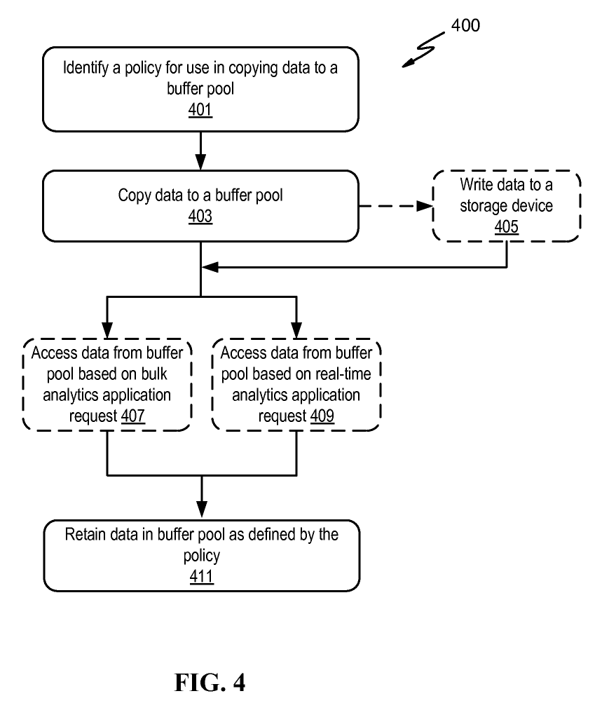

FIG. 4 is a flow diagram of an example process 400 for copying and accessing data from a buffer pool according to a policy in a system that collects statistics and auditing information, consistent with embodiments. In some embodiments, the process 400 begins at block 401 when a policy module identifies a policy for use in coping data to a buffer pool. For example, as described above, the memory storage and consumption system may determine that buffers may be overwritten only when the buffer is the oldest in-time buffer in the system. Accordingly, per block 403, when the data is copied to a particular buffer in the buffer pool, the data overwrites data in the buffer that is the oldest buffer. The policy module may determine the policy or an external application (e.g., application 323 of FIG. 3) may determine the policy. The policy in some embodiments includes retaining data within the in-memory buffer even if the data is written to non-volatile storage.

Per block 405, and in some embodiments, a writer of the system writes the data to a storage device (e.g., disk). The dotted lines in FIG. 4 indicates optional actions within the blocks, as shown at block 405. In other embodiments, the system does not include a storage device and the writer consequently only writes to a buffer pool (e.g., block 403).

Per block 407 and in some embodiments, an analytics application accesses data from the buffer pool based on a bulk request. For example, as discussed above, the analytics application may request data records from 3 a.m. on the first day to 5 p.m. on the first day and access such records.

Per block 409 and in some embodiments, an analytics application accesses data from the buffer pool based on a real-time request for data. For example, the analytics application may poll the system every 2 seconds to request and access real-time data gathered by the system.

Per block 411, the data in the buffer pool is kept in the individual buffers as defined by the policy. Accordingly, the data in the buffer pool may be kept in the individual buffers notwithstanding the data being written to a storage device (e.g., per block 405). This is in contrast to a typical buffer pool that is kept until the data is written to a storage device. This may be useful for real-time and bulk data gathering. In an example illustration, the data that was copied to the buffer pool per block 403 may be kept in the buffer pool until the data within the particular buffer becomes the oldest data stored in the system, at which point the data will be overwritten by more current data. Accordingly, a policy may specify that a set of data is discarded from the in-memory buffer only when the first set of data is an oldest-in-time stored data in the system.

The present invention may be a system, a method, and/or a computer program product. The computer program product may include a computer readable storage medium (or media) having computer readable program instructions thereon for causing a processor to carry out aspects of the various embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a system that collects statistics and auditing information, a first request from an analytics application to access a first set of data;
accessing, by an application program interface (API) of the system, the first set of data within an in-memory buffer of the system; and
retaining the first set of data within the in-memory buffer as defined by a policy, wherein the policy includes retaining the first set of data within the in-memory buffer even after the first set of data is written to non-volatile storage.

2. The method of claim 1, wherein accessing the first set of data includes accessing a particular data record type.

3. The method of claim 1, wherein the first set of data is real-time data, the method further comprising:
stopping the accessing of the real-time data at a first point in time; and
receiving a second request a second point in time after the first point in time to continue the accessing of the real-time data, wherein the analytics application is synchronized to the system to continue access of the real-time data at the first point in time corresponding to the stopping.

4. The method of claim 1, wherein the retaining the first set of data within the in-memory buffer as defined by the policy includes discarding the first set of data from the in-memory buffer only when the first set of data is an oldest-in-time stored data in the system.

5. The method of claim 1, wherein the system is a system management facilities (SMF) system.

6. The method of claim 1, wherein the first set of data is bulk data, and wherein the bulk data is two or more units of data that is chunked together, the method further comprising accessing, by the API, the bulk data within one or more in-memory buffers of the system.

7. The method of claim 6, wherein accessing the bulk data comprises accessing the bulk data within a particular time range.

8. The method of claim 1, wherein the in-memory buffer is a part of a plurality of buffers, and wherein a first header provides reference to an oldest set of data within a first buffer of the plurality of buffers, and a second header provides reference to a newest set of data within a second buffer of the plurality of buffers.

9. A system comprising:
a computing device that collects statistics and audition information, the computing device having a processor; and
a computer readable storage medium having program instructions embodied therewith, the program instructions executable by the processor to cause the system to:
receive a first request from an analytics application to access a first set of data;
access the first set of data within an in-memory buffer of the system; and
retain the first set of data within the in-memory buffer as defined by a policy, wherein the policy includes retaining the first set of data within the in-memory buffer even after the first set of data is written to non-volatile storage.

10. The system of claim 9, wherein the first set of data is real-time data, and wherein the program instructions executable by the processor further cause the system to:
stop the accessing of the real-time data at a first point in time; and
receive a second request a second point in time after the first point in time to continue the accessing of the real-time data, wherein the analytics application is synchronized to the system to continue access of the real-time data at the first point in time corresponding to the stopping.

11. The system of claim 9, wherein the program instructions executable by the processor further cause the system to discard, according to the policy, the first set of data from the in-memory buffer only when the first set of data is an oldest-in-time stored data in the system.

12. The system of claim 9, wherein the computing device is a system management facilities (SMF) system.

13. The system of claim 9, wherein the first set of data is bulk data, and wherein the bulk data is two or more units of data that is chunked together, and wherein the program instructions executable by the processor further cause the system to access the bulk data within one or more in-memory buffers of the system.

14. The system of claim 9, wherein the in-memory buffer is a part of a plurality of buffers, and wherein a first header provides reference to an oldest set of data within a first buffer of the plurality of buffers, and a second header provides reference to a newest set of data within a second buffer of the plurality of buffers.

15. A computer program product comprising a computer readable storage medium having program code embodied therewith, the program code comprising computer readable program code configured for:
receiving, by a system that collects statistics and auditing information, a first request from an analytics application to access a first set of data;
accessing, by an application program interface (API) of the system, the first set of data within an in-memory buffer of the system; and
retaining the first set of data within the in-memory buffer as defined by a policy, wherein the policy includes retaining the first set of data within the in-memory buffer even after the first set of data is written to non-volatile storage.

16. The computer program product of claim 15, wherein the first set of data is real-time data, and wherein the computer readable program code is further configured for:
stopping the accessing of the real-time data at a first point in time; and
receiving a second request a second point in time after the first point in time to continue the accessing of the real-time data, wherein the analytics application is synchronized to the system to continue access of the real-time data at the first point in time corresponding to the stopping.

17. The computer program product of claim 15, wherein the computer readable program code configured for retaining the first set of data within the in-memory buffer as defined by the policy includes discarding the first set of data from the in-memory buffer only when the first set of data is an oldest-in-time stored data in the system.

18. The computer program product of claim 15, wherein the system is a system management facilities (SMF) system.

19. The computer program product of claim 15, wherein the first set of data is bulk data, and wherein the bulk data is two or more units of data that is chunked together, and wherein the program readable program code is further configured for accessing, by the API, the bulk data within one or more in-memory buffers of the system, and wherein the accessing the bulk data comprises accessing the bulk data within a particular time range.

20. The computer program product of claim 15, wherein the in-memory buffer is a part of a plurality of buffers, and wherein a first header provides reference to an oldest set of data within a first buffer of the plurality of buffers, and a second header provides reference to a newest set of data within a second buffer of the plurality of buffers.
